(19) United States
(12) Patent Application Publication
(10) Pub. No.: US 2009/0148691 A1
(43) Pub. Date: Jun. 11, 2009

(54) Hard coating composition, anti-reflection film, and display device including the same

(76) Inventors: Young Cheol Lee, Uiwang-si (KR); Kyoung Ku Kang, Uiwang-si (KR); Hyoung Tae Lim, Uiwang-si (KR)

Correspondence Address: LEE & MORSE, P.C., 3141 FAIRVIEW PARK DRIVE, SUITE 500, FALLS CHURCH, VA, 22042, US

(21) Appl. No.: 12/314,479

(22) Filed: Dec. 11, 2008

(30) Foreign Application Priority Data
Dec. 11, 2007 (KR) 10-2007-0128288

(51) Int. Cl. B32B 5/16; B32B 27/06; B32B 27/30

(52) U.S. Cl. 428/328; 428/447; 428/336; 428/522; 428/697

(57) ABSTRACT

An anti-reflection film including a plastic transparent substrate, a low refractive index layer, and a high refractive index hard coating layer, wherein the high refractive index hard coating layer includes an inorganic oxide including Ga doped ZnO particles in a polymer matrix.

### BACKGROUND OF THE INVENTION

1. Field of the Invention

Embodiments relate to a hard coating composition, an anti-reflection film, and a display device including the same. More particularly, embodiments relate to a hard coating composition including gallium (Ga) doped zinc oxide (ZnO) particles.

2. Description of the Related Art

Display devices may be used in indoor and outdoor environments on which external light is incident. An image may be formed on a display device by the external light, and image formation by the external light may cause problems for the display device, e.g., deteriorated visibility and light glare. In order to eliminate such problems, an anti-reflection film may be employed.

Antireflection films are known. However, there is a need in the art for an antireflection film that also provides scratch resistance, provides antistatic properties, provides UV light-filtering while maintaining a high level of visible light transmittance, and is economical to manufacture.

### SUMMARY OF THE INVENTION

Embodiments are therefore directed to a hard coating composition, an anti-reflection film, and display device including the same, which substantially overcome one or more of the problems due to the limitations and disadvantages of the related art.

It is therefore a feature of an embodiment to provide a hard coating composition with both anti-reflection and anti-static properties while keeping production costs low.

It is therefore another feature of an embodiment to provide a hard coating composition with high visible light transmission while keeping production costs low.

It is therefore another feature of an embodiment to provide a hard coating composition with UV blocking properties for use in a PDP filter.

At least one of the above and other features and advantages may be realized by providing an anti-reflection film including a plastic transparent substrate, a low refractive index layer, and a high refractive index hard coating layer, wherein the high refractive index hard coating layer includes an inorganic oxide including Ga doped ZnO particles in a polymer matrix.

The hard coating layer may be formed from a hard coating composition including an inorganic oxide including Ga doped ZnO particles, a curable resin, a polymerizable monomer, and a polymerization initiator.

The composition may include about 10 to about 80 wt. % of the GZO particles, based on the weight of the inorganic oxide, the curable resin, the polymerizable monomer, and the polymerization initiator.

The GZO particles may have a particle diameter of about 10 to about 100 nm.

The curable resin may include at least one of a polyvinylacetal resin, a polyvinyl alcohol resin, a polyacryl resin, a polyphenol resin, and a phenoxy resin.

The polymerizable monomer may include at least one of 1,6-hexanediol diacrylate, pentaerythritol triacrylate, pentaerythritol tetraacrylate, and trimethylolpropane triacrylate.

The polymerization initiator may include at least one of a radical generator and an acid generator.

The polymerization initiator may include at least one of a peroxide compound, a benzoin compound, a carbonyl compound, an azo compound, a mixture of diketones and tertiary amines, a cation photoinitiator, an acid anhydride, an α-hydroxyalkylphenone compound, an α,α-dialkoxyacetophenone compound, an α-hydroxyalkylphenone compound, an α-aminoalkylphenone derivative, an α-hydroxyalkylphenone polymer compound, a thioxanthone derivative, an aqueous aromatic ketone compound, and a titanocene compound.

The composition may further include a solvent, wherein the solvent may include at least one of an alcohol, a ketone, an ester, an aromatic compound, and an ether.

The composition may further include at least one of a photo-sensitizer, a polymerization inhibitor, a leveling agent, a wetting agent, a surfactant, a plasticizer, a UV absorber, an antioxidant, an antistatic agent, a silane coupling agent, an inorganic filler, and a defoaming agent.

The composition may include about 10 to about 80 wt. % of the inorganic oxide, about 1 to about 50 wt. % of the curable resin, about 1 to about 30 wt. % of the polymerizable monomer, and about 0.1 to about 20 wt. % of the polymerization initiator.

The composition may further include a coupling agent. The coupling agent may include at least one of an organoalkoxysilane having unsaturated double bonds, epoxy groups, and mercaptan groups, an alkoxy titanium, an alkoxy zirconium, and an inorganic alkoxide.

The high refractive index hard coating layer may have a thickness of about 500 to about 30,000 nm.

The high refractive index hard coating layer may have a refractive index of about 1.55 to about 2.40.

The plastic transparent substrate may have a light transmittance of more than about 80% and a haze value of about 3% or less.

The low refractive index layer may have a thickness of about 50 to about 1,000 nm.

The low refractive index layer may have a refractive index of about 1.35 to about 1.50.

The low refractive index layer may have a refractive index that is at least about 0.05 less than the refractive index of the high refractive index hard coating layer.

At least one of the above and other features and advantages may also be realized by providing a display device including a display unit and an anti-reflection film on the display unit, the anti-reflection film including a plastic transparent substrate, a high refractive index hard coating layer, and a low refractive index layer, wherein the high refractive index hard coating layer includes an inorganic oxide including Ga doped ZnO particles in a polymer matrix.

### BRIEF DESCRIPTION OF THE DRAWINGS

The above and other features and advantages of the present invention will become more apparent to those of ordinary skill in the art by describing in detail exemplary embodiments thereof with reference to the attached drawings, in which:

FIG. 1 illustrates a schematic cross-sectional view of an anti-reflection film according to an exemplary embodiment; and

FIG. 2 illustrates transmittance of each film prepared in Example 1 and Comparative Example 1.

### DETAILED DESCRIPTION OF THE INVENTION

Korean Patent Application No. 10-2007-0128288, filed on Dec. 11, 2007, in the Korean Intellectual Property Office, and entitled: “Antistatic and High Refractive Index Hard Coating Composition and Optical Film Using the Same,” is incorporated by reference herein in its entirety.

Example embodiments will now be described more fully hereinafter with reference to the accompanying drawings; however, they may be embodied in different forms and should not be construed as limited to the embodiments set forth herein. Rather, these embodiments are provided so that this disclosure will be thorough and complete, and will fully convey the scope of the invention to those skilled in the art.

In the drawing figures, the dimensions of layers and regions may be exaggerated for clarity of illustration. It will also be understood that when a layer or element is referred to as being “on” another layer or substrate, it can be directly on the other layer or substrate, or intervening layers may also be present. Further, it will be understood that when a layer is referred to as being “under” another layer, it can be directly under, and one or more intervening layers may also be present. In addition, it will also be understood that when a layer is referred to as being “between” two layers, it can be the only layer between the two layers, or one or more intervening layers may also be present. Like reference numerals refer to like elements throughout.

As used herein, the expressions “at least one,” “one or more,” and “and/or” are open-ended expressions that are both conjunctive and disjunctive in operation. For example, each of the expressions “at least one of A, B, and C,” “at least one of A, B, or C,” “one or more of A, B, and C,” “one or more of A, B, or C” and “A, B, and/or C” includes the following meanings: A alone; B alone; C alone; both A and B together; both A and C together; both B and C together; and all three of A, B, and C together. Further, these expressions are open-ended, unless expressly designated to the contrary by their combination with the term “consisting of.” For example, the expression “at least one of A, B, and C” may also include an nth member, where n is greater than 3, whereas the expression “at least one selected from the group consisting of A, B, and C” does not.

As used herein, the expression “or” is not an “exclusive or” unless it is used in conjunction with the term “either.” For example, the expression “A, B, or C” includes A alone; B alone; C alone; both A and B together; both A and C together; both B and C together; and all three of A, B, and C together, whereas the expression “either A, B, or C” means one of A alone, B alone, and C alone, and does not mean any of both A and B together; both A and C together; both B and C together; and all three of A, B, and C together.

As used herein, the terms “a” and “an” are open terms that may be used in conjunction with singular items or with plural items. For example, the term “a polymerization initiator” may represent a single compound, e.g., benzoyl peroxide, or multiple compounds in combination, e.g., benzoyl peroxide mixed with benzophenone.

Embodiments provide a composition for a high refractive index hard coating layer, which may include an inorganic oxide, a curable resin, a polymerizable monomer, and a polymerization initiator, wherein the inorganic oxide may include particles of ZnO doped with Ga (“GZO particles”. Such inorganic oxide particles may be obtained using GZO with favorable antistatic properties and UV blocking properties, as well as reduced visible light absorption.

Embodiments provide an anti-reflection film which may include a transparent substrate, a high refractive index hard coating layer, and a low refractive index layer, wherein the high refractive index hard coating layer may be prepared using the composition of an embodiment.

GZO particles used herein may be in a sol state, wherein the particles are dispersed in a solvent, or may be prepared by dispersing GZO powder in a solvent using an agitator.

The GZO particles may have a particle diameter of about 10 to about 100 nm. Maintaining the particle diameter at about 10 nm or greater may help ensure that the coating film does not have decreased surface strength and inferior scratch resistance. Maintaining the particle diameter at about 100 nm or less may help ensure the ability to homogeneously disperse the inorganic oxide particles in a laminate type anti-reflection film. Maintaining the particle diameter at about 100 nm or less may also help ensure inorganic oxide particles do not easily settle in a high refractive index layer coating composition, avoiding deterioration of storage stability. Moreover, with an unduly large particle size, an anti-reflection film may exhibit reduced transparency or increased haze. Accordingly, the GZO particles preferably have a particle diameter of not more than about 80 nm, and more preferably not more than about 50 nm.

An amount of the GZO particles in the composition may be about 10 to about 80 % by weight (“wt. %”), based on the weight of the composition exclusive of solvent. Preferably the amount is about 20 to about 70 wt. %. Maintaining the amount of GZO particles at about 10 wt. % or greater may help ensure that antistatic properties are obtained. Maintaining the amount of GZO particles at about 80 wt. % or less may help ensure that the amount of a binder is not decreased relative to the particles, avoiding the problem of not attaining desired adhesion and/or mechanical properties of a coating film.

The composition may further include a coupling agent to enable bonding of GZO particles. The coupling agent may include organoalkoxysilanes (e.g., having unsaturated double bonds, epoxy groups, and/or mercaptan groups in the molecules), alkoxy titanium, alkoxy zirconium, and inorganic alkoxides.

The curable resin may include, e.g., a polymer resin having a hydroxyl group, a thermosetting resin, a UV curable resin, etc. Preferably, the curable resin includes at least one of a polyvinylacetal resin, a polyvinyl alcohol resin, a polyacryl resin, a polyphenol resin, and a phenoxy resin. The curable resin may include at least one of t-butyl aminoethyl acrylate, N,N-dimethylaminoethyl acrylate, N,N-diethylaminoethyl acrylate, N-methacrylo-N,N-dicarboxymethyl-p-phenylenediamine, melamine formaldehyde alkylmonoalcohol, 2-[o-(1′-methacryloyloxyethyl phthalate)], N-methacryloyloxy-N-carboxymethyl piperidine, and 4-methacryloyloxyethyl trimellitic anhydride.

An amount of the curable resin may be about 1 to about 50 wt. % of the composition. Maintaining the amount of the curable resin at about 1 wt. % or greater may help ensure that the curing of the resin is sufficient to form a coating layer. Maintaining the amount of the curable resin at about 50 wt. % or less may help ensure that the amount of particles is not reduced relative to the resin, avoiding problems in controlling the refractive index.

The polymerizable monomer may include at least one of 1,6-hexanediol diacrylate, pentaerythritol triacrylate, pentaerythritol tetraacrylate, and trimethylolpropane triacrylate. The amount of the polymerizable monomer may be about 1 to about 30 wt. % of the composition. Maintaining the amount of the monomer at about 1 wt. % or greater may help ensure that a resultant coating layer does not have a low hardness. Maintaining the amount of the monomer at about 30 wt. % or less may help ensure that the coating layer does not undesirably crack.

The polymerization initiator may include at least one of a radical generator and an acid generator. Preferably, the polymerization initiator includes a combination of a radical generator and an acid generator. Preferably, the polymerization initiator includes peroxide compounds, e.g., benzoin, benzoin methylether, acrylphosphine oxide, benzoyl peroxide, and butyl peroxide; benzoin compounds, e.g., isopropylxanthone and benzoin isopropylether; carbonyl compounds, e.g., benzyl, benzophenone, and acetophenone; azo compounds, e.g., azobisisobutylnitrile and azodibenzoyl; mixtures of diketones and tertiary amines; cation photoinitiators; acid anhydrides; α-hydroxyalkylphenone compounds; α,α-dialkoxyacetophenone compounds; α-hydroxyalkylphenone compounds; α-aminoalkylphenone derivatives; α-hydroxyalkylphenone polymer compounds; thioxanthone derivatives; aqueous aromatic ketone compounds; and/or titanocene compounds.

The amount of the polymerization initiator may be about 0.1 to about 20 wt. % of the composition. The amount of the polymerization initiator is preferably about 0.5 to about 15 wt. % of the hard coating composition. Maintaining the amount of the polymerization initiator at about 0.1 wt. % or greater may help ensure that a reaction is completed and does not require a relatively long time. Maintaining the amount of the polymerization initiator at about 20 wt. % or less may help ensure that excess unreacted initiator is not present, as such excess initiator may increase haze. Using a specific initiator having a functional group which is substantially the same as that in a thermally and photo-polymerizable compound may improve reaction performance.

The solvent may include any one suitable for a hard coating composition. Preferably, the solvent includes alcohols, e.g., methanol, ethanol, propanol, and isopropanol; ketones, e.g., methylisobutylketone and methylethylketone; esters, e.g., methyl acetate and ethyl acetate; aromatic compounds, e.g., toluene, xylene, and benzene; and/or ethers, e.g., diethylether.

The amount of the solvent may be about 50 to about 90 wt. % of the coating composition in view of the viscosity of the composition.

Additional additives may be used, which may include at least one of a photo-sensitizer, a polymerization inhibitor, a leveling agent, a wetting agent, a surfactant, a plasticizer, a UV absorber, an antioxidant, an antistatic agent, a silane coupling agent, an inorganic filler, and a defoaming agent.

Another embodiment provides an anti-reflection film including a transparent substrate, a high refractive index hard coating layer, and a low refractive index layer, wherein the high refractive index hard coating layer is prepared using the high refractive index hard coating composition of an embodiment.

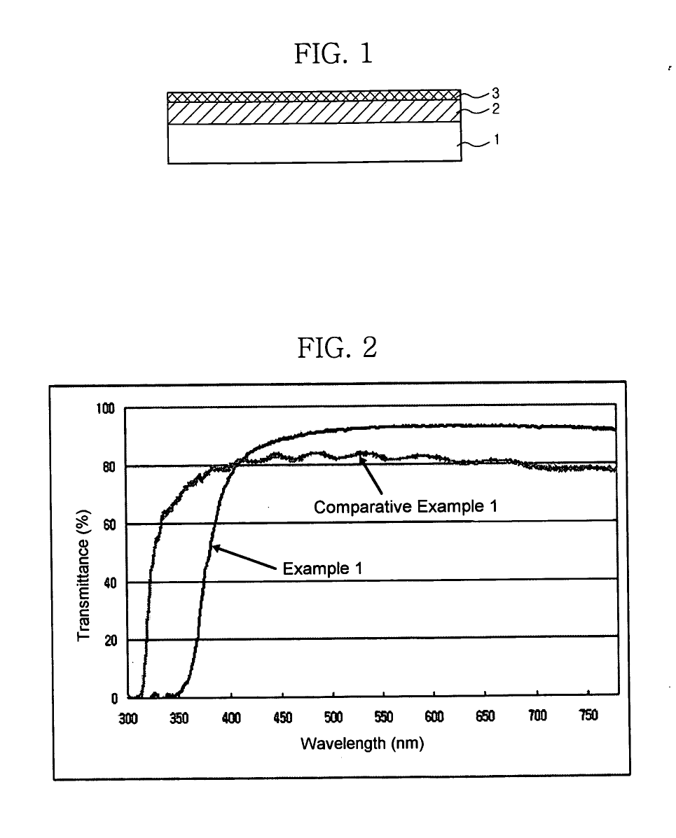

FIG. 1 illustrates a schematic cross-sectional view of an anti-reflection film according to an exemplary embodiment. The anti-reflection film may be fabricated by laminating a high refractive index hard coating layer 2 and a low refractive index layer 3 in this order on a transparent substrate 1.

Hereinafter, a detailed description will be given of individual layers in the anti-reflection film according to an embodiment.

Transparent Substrate

A transparent substrate used in fabricating an anti-reflection film of an embodiment may include a plastic film.

The plastic film is preferably a transparent substrate having a light transmittance of more than about 80% and, more preferably more than about 85%. The transparent substrate may also have a haze value of about 3% or less, preferably, not more than about 1.0%. In addition, the transparent substrate used to fabricate an anti-reflection film of an embodiment may have a refractive index of about 1.5 to about 1.7. The thickness of the transparent film may be about 30 to about 150 μm. Preferably, the thickness is about 40 to about 125 μm.

A polymer used to manufacture the plastic transparent substrate may include a cellulose ester, e.g., cellulose triacetate, cellulose propionate, cellulose butyrate, cellulose acetate propionate, and nitrocellulose; a polyimide; a polycarbonate; a polyester, e.g., polyethylene terephthalate, polyethylene naphthalate, poly-1,4-cyclohexanedimethylene terephthalate, polyethylene 1,2-diphenoxyethane-4,4′-dicarboxylate, and polybutylene terephthalate; a polystyrene, e.g., syndiotactic polystyrene; a polyolefin, e.g., polypropylene, polyethylene, and polymethylpentene; a polysulfone; a polyethersulfone; a polyarylate; a polyetherimide; a polymethyl methacrylate; a polyetherketone; a polyvinylalcohol; and/or a polyvinyl chloride. For an anti-reflection film for a liquid crystal display (LCD) or an organic light emitting display (OLED), cellulose triacetate (TAC) is preferably used as the transparent substrate. In addition, an anti-reflection film used in manufacturing a flat computer monitor, a TV cathode ray tube (CRT), a LCD, and/or a plasma display panel (PDP), may have a transparent substrate made of polyethylene terephthalate (PET).

High Refractive Index Hard Coating Layer

The high refractive index hard coating layer may be formed using the hard coating composition of an embodiment.

The high refractive index hard coating layer may be formed by any suitable method for applying the composition, e.g., roll coating, die coating, bar coating, and spin coating.

The high refractive index hard coating layer may have a refractive index of about 1.55 to about 2.40. Preferably, the layer has a refractive index of about 1.60 to about 2.2. The film thickness of the high refractive index hard coating layer may be about 500 to about 30,000 nm. Preferably, the layer has a thickness of about 1,000 to about 10,000 nm so as to improve characteristics of a hard coating, e.g., high surface durability.

Low Refractive Index Layer

The low refractive index layer may have a refractive index of about 1.35 to about 1.50. Maintaining the refractive index at about 1.35 or greater may help ensure that that the choice of raw materials for the low refractive index layer is not restricted. Maintaining the refractive index at about 1.5 or less may help ensure that the resultant low refractive index layer combined with the high refractive index layer does not deteriorate the antireflection properties of the film. Preferably, the refractive index of the low refractive index layer is about 1.34 to about 1.45. Since a low refractive index layer with reduced refractive index imparts greater antireflection properties to a film, a difference between refractive indexes of both the high refractive index layer and the low refractive index layer is preferably about 0.05 or more. Maintaining the difference at about 0.05 or greater may help ensure that synergistic effects of these layers in an anti-reflection film are not significantly reduced. A film thickness of the low refractive index layer may be defined relative to the high refractive index layer in terms of destructive interference based on optical phenomena. The thickness of the low refractive index layer may be about 50 to about 1,000 nm. Preferably, the thickness is about 50 to about 300 nm.

Hereinafter, embodiments will be explained in greater detail with reference to the following examples. However, these examples are given for the purpose of illustration and are not to be construed as limiting the scope of the disclosure.

Preparation of High Refractive Index Hard Coating Composition

### EXAMPLE 1

23 g of high refractive index GZO particles Pazet-GK (manufactured by Hakusui Co.), 6.3 g of urethane acrylate JH-06 (manufactured by Aekyung Chemicals Co., Ltd.), 1.8 g of acrylate monomer DPHA (manufactured by SK CYTEC Co., Ltd.), 0.9 g of a polymerization initiator Irgacure 184 (manufactured by Ciba-Geigy, Ltd.), and 68 g of isopropyl alcohol (manufactured by Samchun Pure Chemical Co., Ltd.) were mixed together to prepare an antistatic and high refractive index hard coating composition.

### EXAMPLE 2

15 g of high refractive index GZO particles Pazet-GK (manufactured by Hakusui Co.), 6.3 g of urethane acrylate JH-06 (manufactured by Aekyung Chemicals Co., Ltd.), 1.8 g of acrylate monomer DPHA (manufactured by SK CYTEC Co., Ltd.), 0.9 g of a polymerization initiator Irgacure 184 (manufactured by Ciba-Geigy, Ltd.), and 76 g of isopropyl alcohol (manufactured by Samchun Pure Chemical Co., Ltd.) were mixed together to prepare an antistatic and high refractive index hard coating composition.

### COMPARATIVE EXAMPLE 1

A hard coating composition was prepared by the same procedure as in Example 1 except that 21 g of ATO (ATO-IPA, manufactured by Advanced Nano Products Co., Ltd.) was used as the high refractive index particles.

Fabrication of Anti-Reflection Film

Using a PET film A4300 (manufactured by Toyobo Co., Ltd.) as a transparent substrate and each composition prepared in Examples 1 and 2, and Comparative Example 1, respectively, a laminate was fabricated by a bar coating process. As an antistatic and high refractive index hard coating layer, the composition was applied to the substrate using a #12 bar, followed by drying and curing the coated substrate to form a high refractive index coating layer with a film thickness of 3 μm.

After laminating the high refractive index hard coating layer on the substrate, a low refractive index layer, with a film thickness of 100 nm, was formed. This low refractive index layer was formed by the same process for formation of the high refractive index hard coating layer except that a commercially available low refractive index coating composition TU2157 (manufactured by JSR Co.) was applied to the substrate using a #4 bar, resulting in an anti-reflection film.

Drying and curing conditions are as follows: the drying was conducted at 80° C. for 2 minutes while UV curing was performed with UV curing equipment using an 80 W/cm high pressure mercury lamp at 300 to 10,000 mJ/cm².

Analysis and Results

For each of the anti-reflection films prepared by the above Examples and Comparative Example, light fastness (or light resistance) was determined according to the following procedures and the results are shown in Table 1.

(1) Measurement of haze and transmittance: Using an NHD-2000 (manufactured by Nippon Denshoku Kogyo Co.), haze and transmittance of the film were measured.

(2) Measurement of reflectance: Using a UV-Vis spectrophotometer (manufactured by Perkin Elmer Co.), reflectance of the film was measured after sanding a rear side of the film with sand paper and applying a flat black paint to the same.

(3) Measurement of electric resistance: Using an MCP-HT450 (manufactured by Mitsubishi Chemical Co.), sheet resistance of the film was measured.

TABLE 1

| | Trans- | | Surface | Mean | Minimum |
|---|---|---|---|---|---|
| | mittance | | resistance | reflectance | reflectance |
| | (%) | Haze | (Ω/□) | (@380-@780) | (@380-@780) |
| Exam- | 92.97 | 0.94 | 6.010¹⁰ | 2.25 | 1.51 |
| ple 1 | | | | | |
| Exam- | 93.12 | 0.95 | 5.3 × 10¹⁰ | 2.29 | 1.51 |
| ple 2 | | | | | |
| Com- | 82.88 | 0.55 | 3.0 × 10¹⁰ | 2.38 | 1.52 |
| par- | | | | | |
| ative | | | | | |
| exam- | | | | | |
| ple 1 | | | | | |

From the results, it can be seen that the anti-reflection film fabricated using ATO particles hs considerably reduced optical properties compared to those fabricated using GZO particles. In addition, it can be seen that visible light transmittance of the anti-reflection films obtained using GZO particles according to the Examples 1 and 2 are at least 10% higher than that obtained using ATO particles, although both cases have similar reflection behavior.

As is apparent from the above, the composition of an embodiment including GZO particles as an inorganic oxide may effectively be used in manufacturing an anti-reflection film that has antistatic, high refractive index, and UV blocking properties, exhibits favorable characteristics of a hard coating such as high surface durability, and has merits in price competitiveness.

As described herein, an anti-reflection film according to embodiments may have an antistatic and high refractive index hard coating layer with favorable hard coating characteristics such as high surface durability, as well as an existing antistatic high refractive index layer, which is fabricated by introducing a specific inorganic oxide that has excellent optical properties and UV blocking properties and, in addition, an economic advantage.

Exemplary embodiments of the present invention have been disclosed herein, and although specific terms are employed, they are used and are to be interpreted in a generic and descriptive sense only and not for purpose of limitation. Accordingly, it will be understood by those of ordinary skill in the art that various changes in form and details may be made without departing from the spirit and scope of the present invention as set forth in the following claims.

What is claimed is:

1. An anti-reflection film, comprising:
a plastic transparent substrate;
a low refractive index layer; and
a high refractive index hard coating layer, wherein the high refractive index hard coating layer includes an inorganic oxide including Ga doped ZnO particles in a polymer matrix.

2. The anti-reflection film as claimed in claim 1, wherein hard coating layer is formed from a hard coating composition including:
an inorganic oxide including Ga doped ZnO particles,
a curable resin,
a polymerizable monomer, and
a polymerization initiator.

3. The antireflection film as claimed in claim 2, wherein the hard coating composition includes about 10 to about 80 wt. % of the GZO particles, based on the weight of the inorganic oxide, the curable resin, the polymerizable monomer, and the polymerization initiator.

4. The anti-reflection film as claimed in claim 2, wherein the GZO particles have a particle diameter of about 10 to about 100 nm.

5. The anti-reflection film as claimed in claim 2, wherein the curable resin includes at least one of a polyvinylacetal resin, a polyvinyl alcohol resin, a polyacryl resin, a polyphenol resin, and a phenoxy resin.

6. The anti-reflection film as claimed in claim 2, wherein the polymerizable monomer includes at least one of 1,6-hexanediol diacrylate, pentaerythritol triacrylate, pentaerythritol tetraacrylate, and trimethylolpropane triacrylate.

7. The anti-reflection film as claimed in claim 2, wherein the polymerization initiator includes at least one of a radical generator and an acid generator.

8. The anti-reflection film as claimed in claim 7, wherein the polymerization initiator includes at least one of a peroxide compound, a benzoin compound, a carbonyl compound, an azo compound, a mixture of diketones and tertiary amines, a cation photoinitiator, an acid anhydride, an α-hydroxyalkylphenone compound, an α,α-dialkoxyacetophenone compound, an α-hydroxyalkylphenone compound, an α-aminoalkylphenone derivative, an α-hydroxyalkylphenone polymer compound, a thioxanthone derivative, an aqueous aromatic ketone compound, and a titanocene compound.

9. The anti-reflection film as claimed in claim 2, wherein the hard coating composition further includes a solvent, wherein the solvent includes at least one of an alcohol, a ketone, an ester, an aromatic compound, and an ether.

10. The anti-reflection film as claimed in claim 2, wherein the hard coating composition further includes at least one of a photo-sensitizer, a polymerization inhibitor, a leveling agent, a wetting agent, a surfactant, a plasticizer, a UV absorber, an antioxidant, an antistatic agent, a silane coupling agent, an inorganic filler, and a defoaming agent.

11. The anti-reflection film as claimed in claim 2, wherein the hard coating composition includes:
about 10 to about 80 wt. % of the inorganic oxide,
about 1 to about 50 wt. % of the curable resin,
about 1 to about 30 wt. % of the polymerizable monomer, and
about 0.1 to about 20 wt. % of the polymerization initiator.

12. The anti-reflection film as claimed in claim 1, wherein the hard coating composition further includes a coupling agent.

13. The anti-reflection film as claimed in claim 12, wherein the coupling agent includes at least one of an organoalkoxysilane having unsaturated double bonds, epoxy groups, and mercaptan groups, an alkoxy titanium, an alkoxy zirconium, and an inorganic alkoxide.

14. The anti-reflection film as claimed in claim 1, wherein the high refractive index hard coating layer has a thickness of about 500 to about 30,000 nm.

15. The anti-reflection film as claimed in claim 11, wherein the high refractive index hard coating layer has a refractive index of about 1.55 to about 2.40.

16. The anti-reflection film as claimed in claim 1, wherein the plastic transparent substrate has a light transmittance of more than about 80% and a haze value of about 3% or less.

17. The anti-reflection film as claimed in claim 1, wherein the low refractive index layer has a thickness of about 50 to about 1,000 nm.

18. The anti-reflection film as claimed in claim 1, wherein the low refractive index layer has a refractive index of about 1.35 to about 1.50.

19. The anti-reflection film as claimed in claim 1, wherein the low refractive index layer has a refractive index that is at least about 0.05 less than the refractive index of the high refractive index hard coating layer.

20. A display device, comprising:
a display unit; and
an anti-reflection film on the display unit, the anti-reflection film including a plastic transparent substrate, a high refractive index hard coating layer, and a low refractive index layer, wherein the high refractive index hard coating layer includes an inorganic oxide including Ga doped ZnO particles in a polymer matrix.
